(19) United States
(12) Patent Application Publication
(10) Pub. No.: US 2022/0122297 A1
(43) Pub. Date: Apr. 21, 2022

(54) GENERATION APPARATUS AND COMPUTER PROGRAM

(71) Applicant: NIPPON TELEGRAPH AND TELEPHONE CORPORATION, Tokyo (JP)

(72) Inventors: Shota ORIHASHI, Musashino-shi, Tokyo (JP); Shinobu KUDO, Musashino-shi, Tokyo (JP); Ryuichi TANIDA, Musashino-shi, Tokyo (JP); Atsushi SHIMIZU, Musashino-shi, Tokyo (JP)

(73) Assignee: NIPPON TELEGRAPH AND TELEPHONE CORPORATION, Tokyo (JP)

(21) Appl. No.: 17/431,678

(22) PCT Filed: Feb. 3, 2020
(86) PCT No.: PCT/JP2020/003955

§ 371 Date: Aug. 17, 2021

(30) Foreign Application Priority Data
Feb. 19, 2019 (JP) 2019-027405

(51) Int. Cl. G06T 9/00; G06T 7/215; G06N 3/08; G06N 3/04

(52) U.S. Cl. CPC G06T 9/002; G06T 7/215; G06T 2207/20084; G06N 3/0454; G06T 2207/20081; G06N 3/08

(57) ABSTRACT

A generation apparatus includes an interpolation unit that generates, from a moving image including a plurality of frames, an interpolated frame in which some regions in one or more frames included in the moving image are interpolated, and a discrimination unit that discriminates whether a plurality of input frames is interpolated frames in which some regions in the plurality of input frames is interpolated. The discrimination unit includes a temporal direction discrimination unit that discriminates time-wise the plurality of input frames, a spatial direction discrimination unit that discriminates space-wise the plurality of input frames, and an integrating unit that integrates discrimination results from the temporal direction discrimination unit and the spatial direction discrimination unit.

### TECHNICAL FIELD

The present invention relates to a generation apparatus and a computer program.

### BACKGROUND ART

There is known an image interpolation technique for estimating a region with a missing part (hereinafter referred to as “missing region”) from an image with a partially missing part in the image to interpolate the missing region. With the image interpolation technique, it is possible not only to interpolate an image, which is the original purpose, but also to apply this technique to reduction of an encoding amount required for an image to be transmitted by using an encoding device in an image lossy compression coding so that an image is caused to have a missing part and then using a decoding device to interpolate the missing region.

In addition, as a technique for interpolating a still image with a missing part by using deep learning, a method using a framework of generative adversarial networks (GANs) is proposed (see, for example, Non Patent Literature 1). In the technique in Non Patent Literature 1, it is possible to learn a network for interpolating a missing region from an adversarial learning with an interpolator network for outputting an image in which a missing region is interpolated (hereinafter referred to as “interpolated image”) according to inputs of an image with the missing region and a mask indicating the missing region and a discriminator network for discriminating whether the input image is an interpolated image or an image without a missing region (hereinafter referred to as “non-missing image”).

Configurations of the interpolator network and the discriminator network in Non Patent Literature 1 are illustrated in FIG. 9. A missing image illustrated in FIG. 9 is generated on the basis of a missing region mask M″ (A should be placed above M, the same applies hereinafter) in which a missing region is represented by 1 and a region without a missing part (hereinafter referred to as “non-missing region”) is represented by 0, and a non-missing image x. In an example illustrated in FIG. 9, a missing image in which a central portion of the image is missing is assumed to be generated. The missing image can be expressed as in the following expression (1) by using an element-wise product of the missing region mask M″ and the non-missing image x. Note that, in the following description, description proceeds on the assumption that the missing image can be expressed as in expression (1).

[Math. 1]

x⊙(1−\hat{M}) ⊙ indicates element-wise product of matrix (1)

An interpolator network G receives, as an input, a missing image represented as in expression (1), and outputs an interpolated image. The interpolated image may be represented as in the following expression (2): Note that, in the following description, description proceeds on the assumption that the interpolated image can be expressed as in expression (2).

[Math. 2]

G(x⊙(1−\hat{M}),\hat{M}) (2)

A discriminator network D receives, as an input, the image x, and outputs a probability D(x) where the image x is an interpolated image. At this time, on the basis of a framework of learning of generative adversarial networks, parameters of the interpolator network G and the discriminator network D are alternately updated according to following equation (3) to optimize the following objective function V:

$$\begin{matrix}[ Math . 3 ] & \\ {min}_{G} {max}_{D} V ( G , D ) = {𝔼}_{x ∈ X} [ L ( x , \hat{M} ) + log D ( x ) + α log ( 1 - D ( G ( x ⊙ ( 1 - \hat{M} ) , \hat{M} ) ) ) ] & ( 3 )\end{matrix}$$

Here, X in equation (3) represents a distribution of a group of images of supervised data, and L (x, M\hat{ }) represents a squared error of pixels of the image x and an interpolated image, as in the following equation (4):

[Math. 4]

L(x,\hat{M})=∥\hat{M}⊙(x−G(x⊙(1−\hat{M}),\hat{M}))∥² (4)

Further, a indicated in equation 3 denotes parameters representing a weight of the squared error of the pixels and an error propagated from the discriminator network D in training the interpolator network G.

Next, a technique for interpolating a moving image including a missing image is considered by applying the technique in Non-Patent Literature 1 to a moving image where a plurality of still images serving as frames included in the moving image are continuous in a temporal direction. A simple method includes a method of interpolating a moving image by independently applying the technique described in Non Patent Literature 1 to each frame included in the moving image. However, in this method, a missing region is interpolated where each frame is used as an independent still image, and thus, it is not possible to obtain an output with continuity in a temporal direction required for a moving image.

Thus, as illustrated in FIG. 10, a method is contemplated in which a moving image including a missing image is input, as 3D data obtained by combining each frame in a channel direction, to the interpolator network G, and an interpolation result well consistent both in a spatial direction and a temporal direction is output. At this time, as in the case of a still image, the discriminator network D discriminates whether the input moving image is an interpolated moving image or a moving image not including a missing image, and parameters of the interpolator network G and the discriminator network D are alternately updated to construct a network with which it is possible to achieve interpolation of the moving image.

### CITATION LIST

### Non Patent Literature

NPL 1: D. Pathak, P. Krahenbuhl, J. Donahue, T. Darrell, A. A. Efros, “Context Encoders: Feature Learning by Inpainting”, Computer Vision and Pattern Recognition (cs. CV); Artificial Intelligence (cs. AI); Graphics (cs. GR); Machine Learning (cs. LG), pp. 2536 to 2544, 2016.

### SUMMARY OF THE INVENTION

### Technical Problem

In the method described above, it is necessary to output an image consistent in a temporal direction while establishing consistency in a spatial direction for each frame, and thus, the generation by the interpolator network G is more difficult than that of a still image. On the other hand, the discriminator network D discriminates whether an input moving image is an interpolated moving image or a moving image not including a missing image for each moving image, and thus, an amount of input information is rich and the difficulty in discrimination is decreased as compared to discrimination of one still image. If the interpolator network G is trained on the basis of a framework of the generative adversarial networks, the training of the discriminator network D tends to precede the training of the interpolator network G, and thus, it is difficult to adjust a training schedule and a network parameter for a future successful training.

Also, if a region in the same position as a missing region in a certain frame can be referred to from another frame, when the interpolator network G outputs a weighted average of another frame that can be referred to, it is not difficult to achieve consistency, in particular, in the temporal direction. This makes it easier for the interpolator network G to acquire an output of an image by means of an average in the temporal direction. However, there is a problem in that blur occurs in the output image, and a texture in the image disappears and a quality of an output image deteriorates.

In light of the foregoing, an object of the present invention is to provide a technique capable of improving a quality of an output image if an interpolation of a moving image is applied to a framework of generative adversarial networks.

### Means for Solving the Problem

One aspect of the present invention is a generation apparatus including an interpolation unit that generates, from a moving image including a plurality of frames, an interpolated frame in which some regions in one or more frames included in the moving image are interpolated and a discrimination unit that discriminates whether a plurality of input frames is interpolated frames in which some regions in the plurality of input frames are interpolated. The discrimination unit includes a temporal direction discrimination unit that discriminates time-wise the plurality of input frames, a spatial direction discrimination unit that discriminates space-wise the plurality of input frames, and an integrating unit that integrates discrimination results from the temporal direction discrimination unit and the spatial direction discrimination unit.

One aspect of the invention is the above-described generation apparatus. In the generation apparatus, the temporal direction discrimination unit uses time-series data of a frame in which only an interpolated region in the plurality of input frames is extracted to output, as a discrimination result, a probability that the plurality of input frames is interpolated frames, and the spatial direction discrimination unit uses a frame input at every input time to output, as a discrimination result, a probability that the plurality of input frames is interpolated frames.

One aspect of the invention is the above-described generation apparatus. In the generation apparatus, if a reference frame in which some or all regions in a frame are not interpolated is included in the plurality of input frames, the temporal direction discrimination unit uses the reference frame and the interpolated frame to output, as a discrimination result, a probability that the plurality of input frames are interpolated frames, and the spatial direction discrimination unit uses an interpolated frame from among the plurality of input frames at every input time to output, as a discrimination result, a probability that the plurality of input frames are interpolated frames.

One aspect of the invention is the above-described generation apparatus. In the generation apparatus, the reference frame includes two frames consisting of a first reference frame and a second reference frame, and the plurality of input frames includes at least the first reference frame, the interpolated frame, and the second reference frame in a chronological order.

One aspect of the invention is the above-described generation apparatus. In the generation apparatus, the discrimination unit updates, on the basis of correct answer rates obtained as results of discriminations performed by the spatial direction discrimination unit and the temporal direction discrimination unit, parameters used for weighting the spatial direction discrimination unit and the temporal direction discrimination unit.

One aspect of the present invention includes an interpolation unit trained by the generation apparatus described above. If a moving image is input, the interpolation unit generates an interpolated frame in which some regions in one or more frames included in the moving image are interpolated.

One aspect of the present invention is a computer program causing a computer to execute an interpolation step of generating, from a moving image including a plurality of frames, an interpolated frame in which some regions in one or more frames included in the moving image are interpolated, and a discrimination step of discriminating whether a plurality of input frames are interpolated frames in which some regions in the plurality of input frames are interpolated. In the discrimination step, the plurality of input frames is discriminated time-wise, the plurality of input frames is discriminated space-wise, and discrimination results in the discrimination step are integrated.

### Effects of the Invention

According to the present invention, if an interpolation of a moving image is applied to a framework of generative adversarial networks, it is possible to improve a quality of an output image.

### BRIEF DESCRIPTION OF DRAWINGS

FIG. 1 is a schematic block diagram illustrating a functional configuration of an image generation apparatus according to a first embodiment.

FIG. 2 is a flowchart illustrating a flow of a learning process performed by the image generation apparatus according to the first embodiment.

FIG. 3 is a diagram illustrating specific examples of a missing image interpolation process, an image division process, and a discrimination process performed by the image generation apparatus according to the first embodiment.

FIG. 4 is a schematic block diagram illustrating a functional configuration of an image generation apparatus according to a second embodiment.

FIG. 5 is a flowchart illustrating a flow of a learning process performed by the image generation apparatus according to the second embodiment.

FIG. 6 is a diagram illustrating specific examples of a missing image interpolation process, an image division process, and a discrimination process performed by the image generation apparatus according to the second embodiment.

FIG. 7 is a schematic block diagram illustrating a functional configuration of an image generation apparatus according to a third embodiment.

FIG. 8 is a flowchart illustrating a flow of a learning process performed by the image generation apparatus according to the third embodiment.

FIG. 9 is a diagram illustrating configurations of an interpolator network and a discriminator network in a technology known in the art.

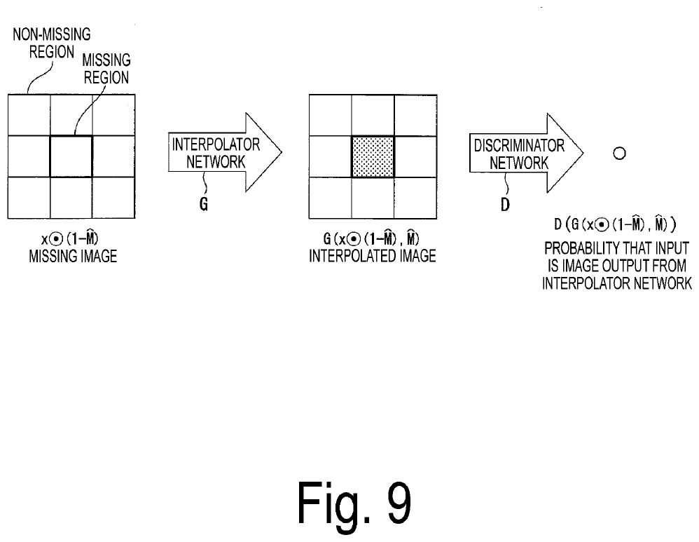

FIG. 10 is a diagram illustrating configurations of an interpolator network and a discriminator network in a technology known in the art.

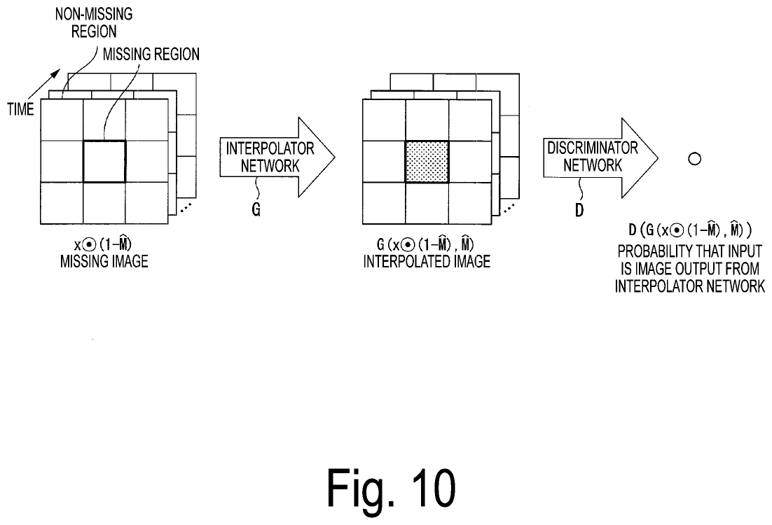

### DESCRIPTION OF EMBODIMENTS

Embodiments of the present invention will be described below with reference to the drawings.

In the following description, adversarial learning of generation and discrimination by a convolutional neural network is premised, but an object to be trained in the present invention is not limited to the convolutional neural network. That is, the present invention can be applied to any generative model for interpolating and generating an image and any discriminative model for dealing with an image discriminative issue, which can be trained by the generative adversarial networks. Note that the words “image” used in the description of the present invention may be replaced with “frame”.

### First Embodiment

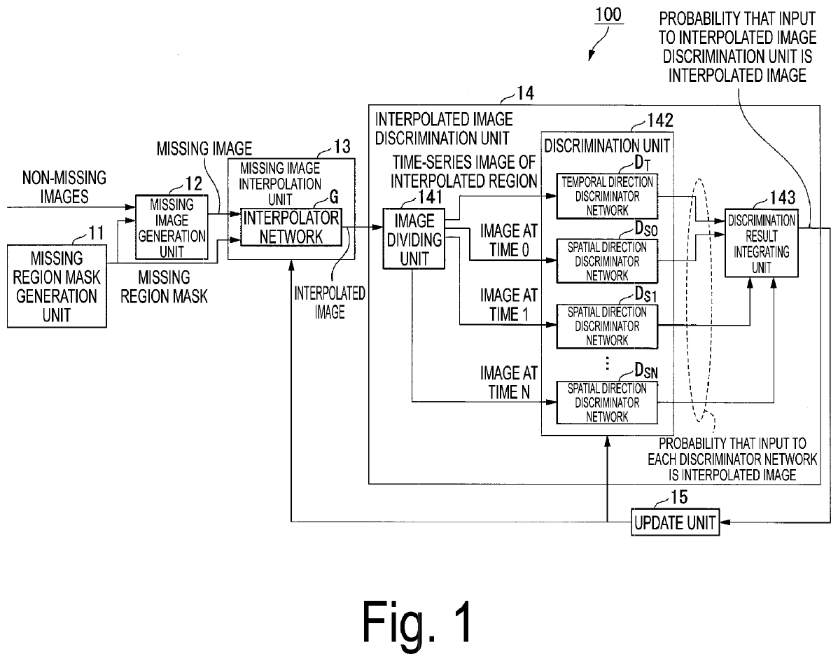

FIG. 1 is a schematic block diagram illustrating a functional configuration of an image generation apparatus 100 according to a first embodiment.

The image generation apparatus 100 includes a central processing unit (CPU), a memory, an auxiliary storage device, and the like, which are connected to each other through a bus, and executes a training program. When the training program is executed, the image generation apparatus 100 functions as an apparatus including a missing region mask generation unit 11, a missing image generation unit 12, a missing image interpolation unit 13, an interpolated image discrimination unit 14, and an update unit 15. Note that all or some functions of the image generation apparatus 100 may be realized using hardware such as an application specific integrated circuit (ASIC), a programmable logic device (PLD), or a field programmable gate array (FPGA). In addition, the training program may be recorded in a computer-readable recording medium. The computer-readable recording medium is, for example, a portable medium such as a flexible disk, a magneto-optical disk, a ROM or a CD-ROM, or a storage device such as a hard disk drive built into a computer system. In addition, the training program may be transmitted and received through an electrical communication line.

The missing region mask generation unit 11 generates a missing region mask. Specifically, the missing region mask generation unit 11 may generate a missing region mask different from each other for non-missing images included in a moving image, and may generate a common missing region mask.

The missing image generation unit 12 generates a missing image on the basis of the non-missing images and the missing region mask generated by the missing region mask generation unit 11. Specifically, the missing image generation unit 12 generates a plurality of missing images on the basis of all the non-missing images included in the moving image and the missing region mask generated by the missing region mask generation unit 11.

The missing image interpolation unit 13 is configured by an interpolator network G, that is, a generator in GAN, and generates an interpolated image by interpolating a missing region in a missing image. The interpolator network G is realized by a convolutional neural network, for example, as used in the technique described in Non-Patent Literature 1. Specifically, the missing image interpolation unit 13 generates a plurality of interpolated images by interpolating a missing region in a missing image on the basis of a missing region mask generated by the missing region mask generation unit 11 and a plurality of missing images generated by the missing image generation unit 12.

The interpolated image discrimination unit 14 is configured by an image dividing unit 141, a discrimination unit 142, and a discrimination result integrating unit 143. The image dividing unit 141 receives, as an input, a plurality of interpolated images, and divides the input interpolated images into a time-series image of the interpolated region and an interpolated image at each time. Here, the time-series image of the interpolated region is data obtained by combining a still image in which only the interpolated region of each interpolated image is extracted in a channel direction.

The discrimination unit 142 is configured by a temporal direction discriminator network D_{T} and spatial direction discriminator networks D_{S0} to D_{SN} (0 to N are subscripts of S, and N is an integer of 1 or more). The temporal direction discriminator network D_{T} receives, as an input, a time-series image of the interpolated region, and outputs a probability that the input image is an interpolated image. The spatial direction discriminator networks D_{S0} to D_{SN} receives, as an input, an interpolated image at a specific time and outputs a probability that the input image is an interpolated image. The spatial direction discriminator networks D_{S0} receives, as an input, an interpolated image at time 0 and outputs a probability that the input image is an interpolated image. The temporal direction discriminator network D_{T} and the spatial direction discriminator networks D_{S0} to D_{SN} may be realized by a convolutional neural network, for example, as used in the technique described in Non Patent Literature 1.

The discrimination result integrating unit 143, receives, as an input, each probability output from the discrimination unit 142, and outputs a probability that the image input to the interpolated image discrimination unit 14 is an interpolated image.

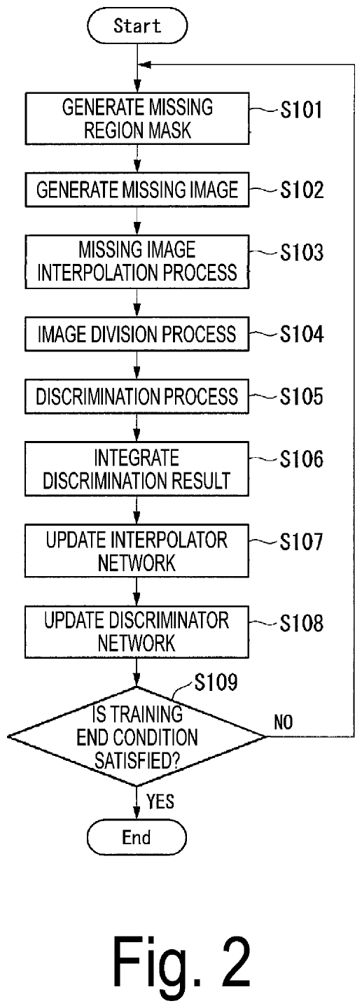

FIG. 2 is a flowchart illustrating a flow of a learning process performed by the image generation apparatus 100 according to the first embodiment.

The missing region mask generation unit 11 generates a missing region mask M\hat{ } (step S101). Specifically, the missing region mask generation unit 11 considers a center region of a screen, a randomly derived region, and the like, as the missing region, and generates a missing region mask M\hat{ } where a missing region is expressed with 1 and a non-missing region is expressed with 0. The missing region mask generation unit 11 outputs the generated missing region mask M\hat{ } to the missing image generation unit 12 and the missing image interpolation unit 13.

The missing image generation unit 12 receives, as an input, a plurality of non-missing images x included in a moving image from outside, and the missing region mask M\hat{ } generated by the missing region mask generation unit 11. The missing image generation unit 12 generates a plurality of missing images on the basis of the plurality of input non-missing images x and the missing region mask M\hat{ } generated by the missing region mask generation unit 11 (step S102). Specifically, the missing image generation unit 12 generates and outputs a missing image obtained when a region evaluated by the missing region mask M\hat{ } in each of the non-missing images x is deleted. If expressed as the binary mask image described above, the missing region mask M\hat{ } can be expressed by an element-wise product of the non-missing image x and the missing region mask M\hat{ } as in expression (1) described above.

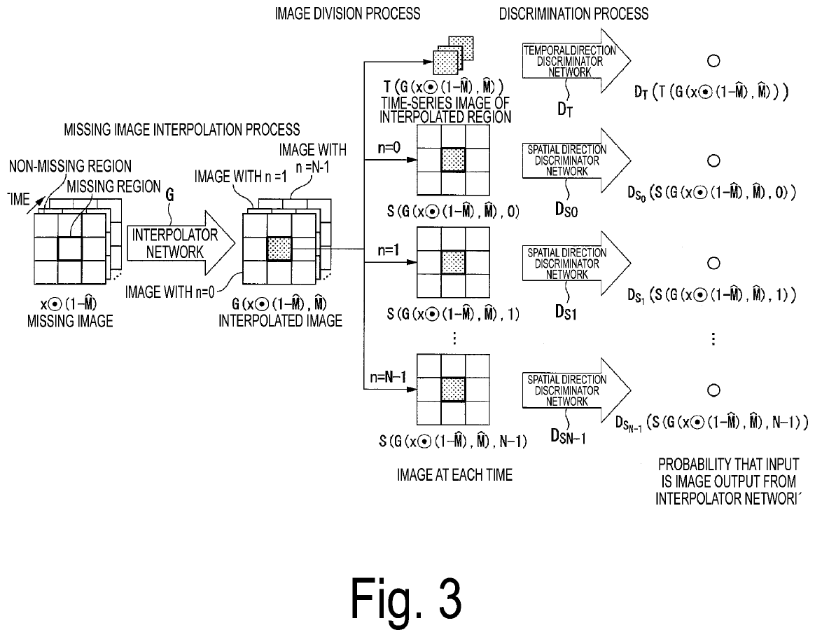

The missing image generation unit 12 outputs the plurality of generated missing images to the missing image interpolation unit 13. As illustrated in FIG. 3, the plurality of missing images generated by the missing image generation unit 12 are arranged in a chronological order. n indicated in FIG. 3 represents a frame number of an interpolated image where n=0, 1, . . . , N−1. FIG. 3 is a diagram illustrating specific examples of a missing image interpolation process, an image division process, and a discrimination process performed by the image generation apparatus 100 according to the first embodiment.

The missing image interpolation unit 13 receives, as an input, the missing region mask M\hat{ } and the plurality of missing images. The missing image interpolation unit 13 interpolates, on the basis of the input missing region mask M\hat{ } and plurality of missing images, a missing region in the missing images to generate a plurality of interpolated images (step S103). The missing image interpolation unit 13 outputs the plurality of generated interpolated images to the image dividing unit 141. The image dividing unit 141 uses the plurality of interpolated images output from the missing image interpolation unit 13 to perform the image division process (step S104). Specifically, the image dividing unit 141 divides the plurality of interpolated images into an input unit of the discriminator network included in the discrimination unit 142. The image dividing unit 141 receives, as an input, the plurality of interpolated images, and outputs a time-series image of the interpolated region and an interpolated image at each time, to each discriminator network.

For example, as illustrated in FIG. 3, the image dividing unit 141 outputs the time-series image of the interpolated region to the temporal direction discriminator network D_{T}, outputs an interpolated image at time 0 to the spatial direction discriminator network D_{S0}, outputs an interpolated image at time 1 to the spatial direction discriminator network D_{S1}, and outputs an interpolated image at time N−1 to the spatial direction discriminator network D_{SN-1}.

Here, when the interpolated image is expressed by expression (5), the time-series image of the interpolated region is expressed by expression (6). Note that when the interpolated region is different depending on each interpolated image, a common portion, a union, or the like of the interpolated region of each interpolated image may be used, for example. Additionally, when the interpolated image is expressed by expression (5), the interpolated image at time n is expressed by expression (7).

[Math. 5]

G(x⊙(1-\hat{M}),\hat{M}) (5)

[Math. 6]

T(G(x⊙(1−\hat{M}),\hat{M})) (6)

[Math. 7]

S(G(x⊙(1−\hat{M}),\hat{M}),n) (7)

The discrimination unit 142 uses the time-series image of the input interpolated region and the interpolated image at each time to output a probability that the image input to each discriminator network is an interpolated image (step S105). Specifically, the temporal direction discriminator network D_{T} included in the discrimination unit 142 receives, as an input, the time-series image of the interpolated region, and outputs a probability that the input image is an interpolated image to the discrimination result integrating unit 143. Note that a probability that an image obtained by the temporal direction discriminator network D_{T} is an interpolated image is expressed by the following expression (8). Each of the spatial direction discriminator networks D_{S0} to D_{SN} included in the discrimination unit 142 receives, as an input, the image at time n, and outputs a probability that the input image is an interpolated image at each time to the discrimination result integrating unit 143. Note that a probability that an image obtained by the spatial direction discriminator networks D_{S0} to D_{SN} is an interpolated image is expressed by the following expression (9). Note that the spatial direction discriminator networks D_{S0} to D_{SN} may be networks having different parameters depending on time n or networks having common parameters.

[Math. 8]

D_{T}(T(G(x⊙(1−\hat{M}),\hat{M}))) (8)

[Math. 9]

D_{S}_{ₙ}(S(G(x⊙(1\hat{M}),\hat{M}),n)) (9)

The discrimination result integrating unit 143 receives, as an input, each probability output from the discrimination unit 142, and outputs a value obtained by integration with the use of the following equation (10), as a final probability for the input image to the interpolated image discrimination unit 14 (step S106).

$$\begin{matrix}[ Math . 10 ] & \\ D ( G ( x ⊙ \hat{M} , \hat{M} ) ) = {w}_{T} {D}_{T} ( T ( G ( x ⊙ ( 1 - \hat{M} ) , \hat{M} ) ) ) + {\sum }_{n = 0}^{N - 1} {w}_{{S}_{n}} {D}_{{S}_{n}} ( S ( G ( x ⊙ ( 1 - \hat{M} ) , \hat{M} ) , n ) ) & ( 10 )\end{matrix}$$

Note that W_{T} and Wₛₙ in the equation (10) are weighting parameters defined in advance (hereinafter, referred to as “weighting parameter”).

The update unit 15 updates a parameter of the interpolator network G as follows (step S107). Here, a parameter of the interpolator network G is updated to obtain an interpolated image not being easily discriminated by the discriminator network D and having a pixel value not greatly apart from non-missing images corresponding to a missing image.

The update unit 15 updates a parameter of the discriminator network D so that the discriminator network D discriminates between an interpolated image and a non-missing image (step S108).

Note that, these update processes are formulated as in the following equation (11) as optimization of an objective function V under the assumption mentioned below. Here, in much the same way as in Non Patent Literature 1, for example, in the update processes, it is assumed that a generator network update process is performed on the basis of a squared error of pixels of an interpolated image and a non-missing image corresponding thereto, and an error propagated by the adversarial learning with the discriminator network, and the discriminator network update process is performed on the basis of a mutual information amount of a value output from the discriminator network and a correct value. In order to optimize the objective function V, the update unit 15 alternately updates parameters of the interpolator network G and the discriminator network D according to the following equation (11).

$$\begin{matrix}[ Math . 11 ] & \\ {min}_{G} {max}_{D} V ( G , D ) = {𝔼}_{x ∈ X} [ L ( x , \hat{M} ) + log D ( x ) + α log ( 1 - D ( G ( x ⊙ ( 1 - \hat{M} ) , \hat{M} ) ) ) ] & ( 11 )\end{matrix}$$

Here, X represents a distribution of a group of images of supervised data, and L (x, M\hat{ }) is a squared error of pixels of an image x and an interpolated image, as in equation (4) above. Further, a denotes a parameter representing a weight of the squared error of the pixels and an error propagated from the discriminator network during training of the interpolator network G. Note that in updating each parameter, a network to be updated is changed at every training repeated according to a correct answer rate of the discriminator network, and a minimization of a squared error of an intermediate layer of the discriminator network is included into an objective function of the generator network, for example. Such a technology known in the art on training of any generative adversarial networks and a neural network may be applied.

Thereafter, the image generation apparatus 100 determines whether a training end condition is satisfied (step S109). The end of training may be determined on the basis of whether training is executed for a previously defined repetition count or may be determined on the basis of a shift in an error function. If the training end condition is satisfied (step S109—Yes), the image generation apparatus 100 ends the processing in FIG. 2.

On the other hand, if the training end condition is not satisfied (step S109—NO), the image generation apparatus 100 repeatedly executes the processing after step S101. As a result, the image generation apparatus 100 performs training of the interpolator network G.

Here, an interpolated image generation apparatus for receiving, as an input, a moving image and outputting an interpolated moving image will be described. Here, in the interpolated image generation apparatus, the interpolator network G trained by the learning process is used. The interpolated image generation apparatus includes an image input unit and a missing image interpolation unit. The image input unit receives, as an input, a moving image including a missing image, from outside. The missing image interpolation unit is configured in much the same way as the missing image interpolation unit 13 in the image generation apparatus 100, and receives, as an input, a moving image via the image input unit. The missing image interpolation unit outputs an interpolated moving image by interpolating the input moving image. Note that the interpolated image generation apparatus may be configured as a single apparatus and may be provided within the image generation apparatus 100.

The image generation apparatus 100 configured as described above divides the discriminator network into a network discriminating an image in a temporal direction only and a network discriminating an image in a spatial direction only to intentionally complicate training of the discriminator network to facilitate the adversarial learning with the interpolator network G. In particular, in a technology known in the art, there is a problem that training of the interpolator network G is facilitated as a weighted average of a referenceable region is output and a texture is easily lost in a unit of frames. In contrast, if the spatial direction discriminator networks D_{S0} to D_{SN} are introduced as in the present invention, it is possible to obtain a parameter of the interpolator network G to realize training for outputting an interpolated image consistent in the spatial direction. As a result, it is possible to prevent loss of a texture to improve interpolation accuracy of the interpolator network G. Thus, if interpolation of a moving image is applied to a framework of the generative adversarial network, it is possible to improve accuracy in quality of an output image.

Modifications

The spatial direction discriminator networks D_{S0} to D_{SN} in the interpolated image discrimination unit 14 are illustrated as networks different for each time, but a common network may be used to derive from an input to an output at each time

### Second Embodiment

A second embodiment differs from the first embodiment in the missing image interpolation process, the image division process, and a discrimination result integration process. In the first embodiment, it is assumed that there is the missing region in all the images included in the moving image, as illustrated in FIG. 3. However, there may be an image (hereinafter, referred to as “reference image”) in which all regions in the image included in a moving image are a non-missing region. Thus, in the second embodiment, a learning method in a case where a reference image is included in an image included in a moving image will be described.

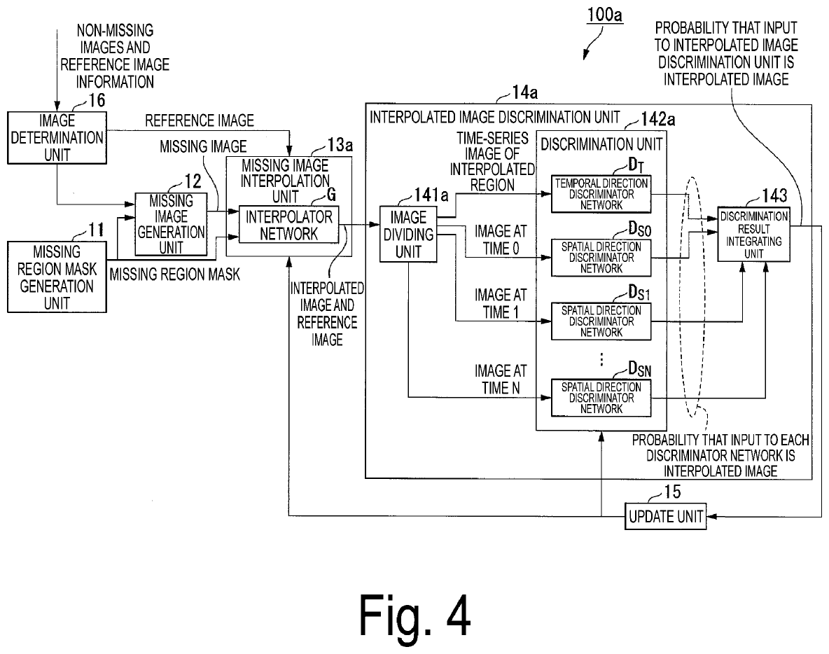

FIG. 4 is a schematic block diagram illustrating a functional configuration of an image generation apparatus 100a according to the second embodiment.

The image generation apparatus 100a includes a CPU, a memory, an auxiliary storage device, and the like, which are connected to each other through a bus, and executes a training program. When the training program is executed, the image generation apparatus 100a functions as an apparatus including the missing region mask generation unit 11, the missing image generation unit 12, a missing image interpolation unit 13a, an interpolated image discrimination unit 14a, the update unit 15, and an image determination unit 16. Note that all or some functions of the image generation apparatus 100a may be realized using hardware such as an ASIC, a PLD, or an FPGA. In addition, the training program may be recorded in a computer-readable recording medium. The computer-readable recording medium is, for example, a portable medium such as a flexible disk, a magneto-optical disk, a ROM or a CD-ROM, or a storage device such as a hard disk drive built into a computer system. In addition, the training program may be transmitted and received through an electrical communication line.

The image generation apparatus 100a differs in configuration from the image generation apparatus 100 that the missing image interpolation unit 13a and the interpolated image discrimination unit 14a are provided instead of the missing image interpolation unit 13 and the interpolated image discrimination unit 14, and the image determination unit 16 is additionally provided. The image generation apparatus 100a is configured in much the same way as the image generation apparatus 100 in other respects. Thus, the image generation apparatus 100a will not be thoroughly described, but the missing image interpolation unit 13a, the interpolated image discrimination unit 14a, and the image determination unit 16 will be described.

The image determination unit 16 receives, as an input, a non-missing image and reference image information. The image determination unit 16 determines on the basis of the input reference image information, which non-missing image, from among non-missing images included in a moving image, is used as the reference image. The reference image information is information for identifying a non-missing image serving as the reference image, and is information indicating what number of the non-missing image, from among non-missing images included in a moving image, is used as the reference image.

The missing image interpolation unit 13a is configured by the interpolator network G, that is, a generator in GAN, and generates an interpolated image by interpolating a missing region in a missing image. Specifically, the missing image interpolation unit 13a generates a plurality of interpolated images by interpolating a missing region in a missing image on the basis of a missing region mask generated by the missing region mask generation unit 11, a plurality of missing images generated by the missing image generation unit 12, and the reference image.

The interpolated image discrimination unit 14a is configured by an image dividing unit 141a, a discrimination unit 142a, and the discrimination result integrating unit 143. The image dividing unit 141a receives, as an input, the plurality of interpolated images and the reference image. The image dividing unit 141a divides each of the input interpolated images into a time-series image of the interpolated region and an interpolated image at each time, and divides the reference image into a time-series image of the interpolated region only. Thus, regarding the reference image, the image dividing unit 141a inputs the reference image only to the temporal direction discriminator network D_{T}. The time-series image of the interpolated region in the second embodiment is data obtained by combining a still image in which only the interpolated region is extracted from each of the interpolated images and the reference image in a channel direction. There is no interpolated region in the reference image, but an interpolated region in another interpolated image is extracted from the reference image and used as a time-series image of the interpolated region.

The discrimination unit 142a is configured by the temporal direction discriminator network D_{T} and the spatial direction discriminator networks D_{S0} to D_{SN}. The temporal direction discriminator network D_{T} receives, as an input, a time-series image of the interpolated region and a time-series image of the reference image, and outputs a probability that the input image is an interpolated image.

The spatial direction discriminator networks D_{S0} to D_{SN} perform processing similar to that performed by a functional component having the same name in the first embodiment.

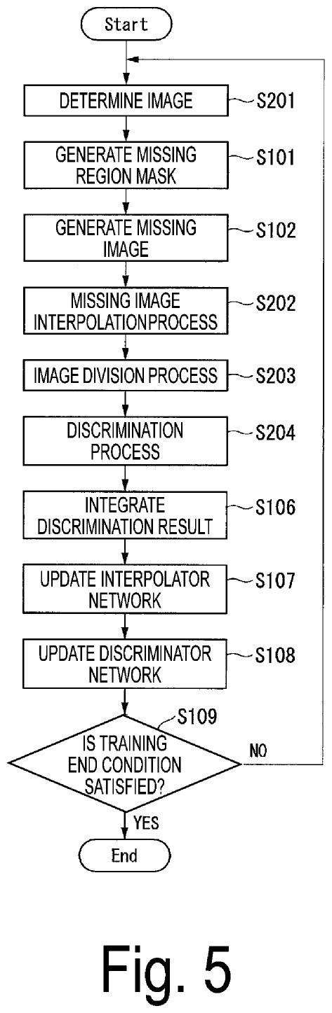

FIG. 5 is a flowchart illustrating a flow of a learning process performed by the image generation apparatus 100a according to the second embodiment. In FIG. 5, reference signs similar to those in FIG. 2 are assigned to processes similar to those in FIG. 2, and the description thereof will be omitted.

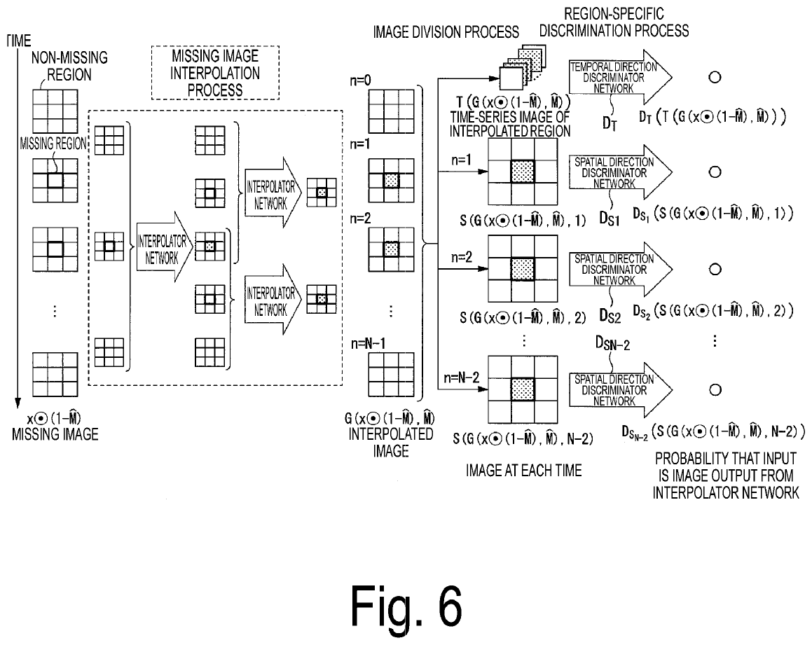

The image determination unit 16 receives, as an input, a non-missing image and reference image information. The image determination unit 16 determines on the basis of the input reference image information, which non-missing image, from among non-missing images included in a moving image, is used as the reference image (step S201). Here, it is assumed that, in an example, information in which the oldest (most distant past) non-missing image and the latest (most distant future) non-missing image in a chronological order from among non-missing images included in a moving image are used as the reference image is included in the reference image information. In this case, the image determination unit 16 uses the most distant past non-missing image and the most distant future non-missing image in a chronological order as the reference image, and outputs the reference image to the missing image interpolation unit 13a. Further, the image determination unit 16 outputs non-missing images which is not included in the reference image information, to the missing image generation unit 12. As a result, the non-missing images output to the missing image generation unit 12 are input, as a missing image, to the missing image interpolation unit 13a. Here, in an example, a reason for employing the oldest non-missing image and the latest non-missing image in a chronological order, from among the non-missing images included in the moving image, is that the interpolation can be advantageously and easily performed with a configuration of the interpolator network G serving as interpolation as illustrated in FIG. 6. That is, the reason is that an image to be interpolated is sandwiched between the reference images in a time series manner. For example, in a case where a time series is a reference image 1->a reference image 2->an image to be interpolated, the image is interpolated by predicting the future or the past. To avoid this, accuracy in interpolation is improved by sandwiching the image to be interpolated between the reference images in a time-series manner.

As illustrated in FIG. 6, images input to the missing image interpolation unit 13a include non-missing images and missing images in a mixed manner. FIG. 6 is a diagram illustrating specific examples of the missing image interpolation process, the image division process, and the discrimination process performed by the image generation apparatus according to the second embodiment. The missing image interpolation unit 13a receives, as an input, a missing region mask M\hat{ }, a plurality of missing images, and a reference image. The missing image interpolation unit 13a constructs an interpolator network for generating a missing region of a missing image at an intermediate time from past and future reference images on the basis of the input missing region mask M\hat{ }, plurality of missing images, and reference image. The missing image interpolation unit 13a iteratively applies the interpolator network to achieve the missing image interpolation process (step S202). At this time, a common or different parameter may be employed for each interpolator network. The missing image interpolation unit 13a outputs a plurality of generated interpolated images and the reference image, to the image dividing unit 141a.

The image dividing unit 141a uses the plurality of interpolated images and the reference image output from the missing image interpolation unit 13a to perform the image division process (step S203). Specifically, the image dividing unit 141a divides the plurality of interpolated images into an input unit of the discriminator network included in the discrimination unit 142a. The image dividing unit 141a receives, as an input, the plurality of interpolated images and the reference image, and outputs a time-series image of the interpolated region and an interpolated image at each time, to each discriminator network. In the second embodiment, a region corresponding to the interpolated region in the reference image is also included in the time-series image of the interpolated region output from the temporal direction discriminator network D_{T}. Further, the image at each time input to the spatial direction discriminator networks D_{S0} to D_{SN} does not include the reference image, that is, n=1, 2, . . . , N−2.

For example, as illustrated in FIG. 6, the image dividing unit 141a outputs the time-series image of the interpolated region to the temporal direction discriminator network D_{T}, outputs an interpolated image at time 1 to the spatial direction discriminator network D_{S1}, and outputs an interpolated image at time 2 to the spatial direction discriminator network D_{S2}, and outputs an interpolated image at time N−2 to the spatial direction discriminator network D_{SN-2}. As illustrated in FIG. 6, a part of the reference image is output only to the temporal direction discriminator network D_{T}. That is, the temporal direction discriminator network D_{T} uses the time-series images of the interpolated region in the reference image and the interpolated image to output the probabilities that the input images are an interpolated image, to the discrimination result integrating unit 143.

The discrimination result integrating unit 143 receives, as an input, each of the probabilities output from the discrimination unit 142a, and outputs a value obtained by integration with the use of the following equation (12), as a final probability for the input image to the interpolated image discrimination unit 14a (step S204).

[Math. 12]

D(G(x⊙(1−\hat{M}),\hat{M}))=w_{T}D_{T}(T(G(x⊙(1−\hat{M}),\hat{M})))+Σₙ₌₁^{N-2}w_{S}_{ₙ}D_{S}_{ₙ}(S(G(x⊙(1−\hat{M}),\hat{M}),n)) (12)

Thereafter, the training is continued until the training end condition is satisfied, as a result, the image generation apparatus 100a performs the training of the interpolator network G. Next, an interpolated image generation apparatus for outputting an interpolated moving image when a moving image is input will be described by using the interpolator network G trained by the learning process. The interpolated image generation apparatus includes an image input unit and a missing image interpolation unit. The image input unit receives, as an input, a moving image including a missing image, from outside. The missing image interpolation unit is configured in much the same way as the missing image interpolation unit 13a in the image generation apparatus 100, and receives, as an input, the moving image via the image input unit. The missing image interpolation unit outputs an interpolated moving image by interpolating the input moving image. Note that the interpolated image generation apparatus may be configured as a single apparatus and may be provided within the image generation apparatus 100a.

The image generation apparatus 100a configured as described above is configured to use, as the reference image, a non-missing image for training, and in using a non-missing image for training, inputs the reference image to the temporal direction discriminator network D_{T} only. In expanding technique known in the art, there is a problem that if there is the reference image, when the interpolator network outputs a weighting sum of the reference image, a texture in the spatial direction is easily lost. In contrast, in the present invention, the reference image is applied only to discrimination of the consistency in the temporal direction only, and thus, a texture is not easily lost. Thus, it is possible to improve accuracy in interpolation of the interpolator network G. Thus, if interpolation of a moving image is applied to a framework of the generative adversarial network, it is possible to improve accuracy in quality of an output image.

Modifications

In the above description, the configuration is described where one frame in the past and one frame in the future are employed as the reference image, but how the reference image is provided is not limited thereto. That is, for example, a plurality of past non-missing images may be the reference image, and a non-missing image at an intermediate time, from among images included in the moving image, may be the reference image.

### Third Embodiment

In a third embodiment, the image generation apparatus 100 changes a weighting parameter in an interpolator network update process and a discriminator network update process.

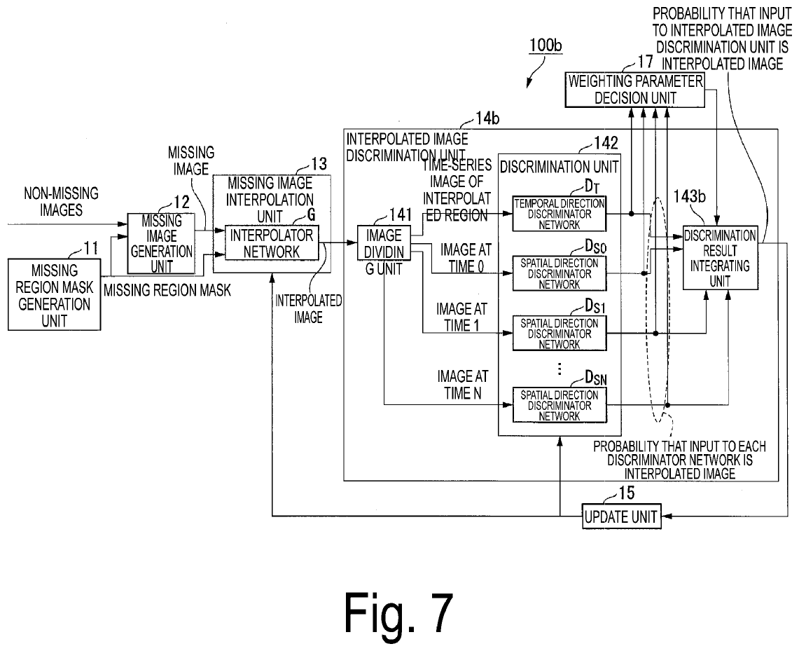

FIG. 7 is a schematic block diagram illustrating a functional configuration of an image generation apparatus 100b according to the third embodiment.

The image generation apparatus 100b includes a CPU, a memory, an auxiliary storage device, and the like, which are connected to each other through a bus, and executes a training program. When the training program is executed, the image generation apparatus 100b functions as an apparatus including the missing region mask generation unit 11, the missing image generation unit 12, the missing image interpolation unit 13, an interpolated image discrimination unit 14b, the update unit 15, and a weighting parameter decision unit 17. Note that all or some functions of the image generation apparatus 100b may be realized using hardware such as an ASIC, a PLD, or an FPGA. In addition, the training program may be recorded in a computer-readable recording medium. The computer-readable recording medium is, for example, a portable medium such as a flexible disk, a magneto-optical disk, a ROM or a CD-ROM, or a storage device such as a hard disk drive built into a computer system. In addition, the training program may be transmitted and received through an electrical communication line.

The image generation apparatus 100b differs in configuration from the image generation apparatus 100 that the interpolated image discrimination unit 14b is provided instead of the interpolated image discrimination unit 14 and the weighting parameter decision unit 17 is additionally provided.

The image generation apparatus 100b is configured in much the same way as the image generation apparatus 100 in other respects. Thus, the image generation apparatus 100b will not be thoroughly described, but the interpolated image discrimination unit 14b and the weighting parameter decision unit 17 will be described.

The weighting parameter decision unit 17 receives, as an input, a probability that an image input to each discriminator network is an interpolated image to decide a weighting parameter used for training. Specifically, the weighting parameter decision unit 17 uses a probability that an image input to each discriminator network (the temporal direction discriminator network D_{T} and the spatial direction discriminator networks D_{S0} to D_{SN}) obtained by the discrimination unit 142 is an interpolated image to calculate a correct answer rate for each discriminator network, and decides a weighting parameter used for training, on the basis of the calculated correct answer rate for each discriminator network.

The interpolated image discrimination unit 14b is configured by the image dividing unit 141, the discrimination unit 142, and a discrimination result integrating unit 143b. The discrimination result integrating unit 143b, receives, as an input, each probability output from the discrimination unit 142, and outputs a probability that the image input to the interpolated image discrimination unit 14b is an interpolated image. At this time, the interpolated image discrimination unit 14b calculates a probability that the image input to the interpolated image discrimination unit 14b is an interpolated image. Here, a weighting parameter obtained by the weighting parameter decision unit 17 may be employed for the weighting parameter. Note that if a weight allowing the discriminator network D having a low correct answer rate to be more weighted is applied, discrimination of the discriminator network D is disadvantageous, and thus, it is necessary that the weight is reversed or employs a fixed value in the integration.

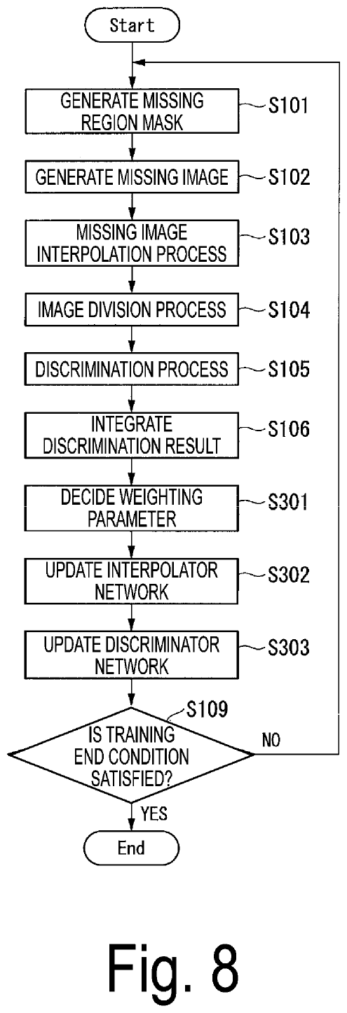

FIG. 8 is a flowchart illustrating a flow of a learning process performed by the image generation apparatus 100b according to the third embodiment. In FIG. 8, reference signs similar to those in FIG. 2 are assigned to processes similar to those in FIG. 2, and the description thereof will be omitted.

The weighting parameter decision unit 17 uses a probability that an input to each network is an interpolated image, which probability is obtained as a result of a region-specific discrimination process, to calculate a correct answer rate for each discriminator network. Derivation of the correct answer rate may be based on a correct answer rate derived from a past training iteration. A weighting parameter to be applied to either or both of the interpolator network update process and the discriminator network update process is decided on the basis of the derived correct answer rate (step S301). For example, in a case of accelerating the training of the interpolator network G, the weighting parameter decision unit 17 decides a weighting parameter so that a value of a weighting parameter corresponding to the discriminator network having a higher correct answer rate is relatively large. In a case of accelerating the training of the discriminator network, the weighting parameter decision unit 17 decides a weighting parameter so that a value of a weighting parameter corresponding to the discriminator network having a lower correct answer rate is relatively large. Thus, the weighting parameter decision unit 17 has a different target for which a weighting parameter is decided, depending on a target for which the training is accelerated.

The update unit 15 updates a parameter of the interpolator network G to obtain an interpolated image not being easily discriminated by the discriminator network D and having a pixel value not greatly apart from the non-missing image corresponding to the missing image (step S302). For example, in a case of accelerating the training of the interpolator network, the update unit 15 relatively increases a value of a weighting parameter corresponding to the discriminator network having a high correct answer rate and performs the interpolator network update process. Specifically, in a case of assuming the first embodiment as in FIG. 3, when the correct answer rates of the temporal direction discriminator network D_{T} and the spatial direction discriminator networks D_{S0} to D_{SN} are represented by a_{T} and a_{SN}, respectively, the update unit 15 performs the interpolator network update process as the following equation (13).

$$\begin{matrix}[ Math . 13 ] & \\ {W}_{T} = \frac{{a}_{T}}{{a}_{T} + {\sum }_{n = 0}^{N - 1} {a}_{{S}_{n}}} \\ {W}_{{S}_{n}} = \frac{{a}_{{S}_{n}}}{{a}_{T} + {\sum }_{n = 0}^{N - 1} {a}_{{S}_{n}}} & ( 13 )\end{matrix}$$

The update unit 15 updates a parameter of the discriminator network D so that the discriminator network D discriminates an interpolated image and a non-missing image (step S303). For example, in a case of accelerating the training of the discriminator network, the update unit 15 relatively increases a value of a weighting parameter corresponding to the discriminator network having a low correct answer rate and performs the discriminator network update process. Specifically, in a case of assuming the first embodiment as illustrated in FIG. 3, when the correct answer rates of the temporal direction discriminator network D_{T} and the spatial direction discriminator networks D_{S0} to D_{SN} are represented by a_{T} and a_{SN}, respectively, the update unit 15 performs the interpolator network update process as the following equation (14). Note that a network to which the interpolator network update process is applied may be decided on the basis of, for example, a value of an error function of each network.

$$\begin{matrix}[ Math . 14 ] & \\ {W}_{T} = \frac{\frac{1}{{a}_{T}}}{\frac{1}{{a}_{T}} + {\sum }_{n = 0}^{N - 1} \frac{1}{{a}_{{S}_{n}}}} \\ {W}_{{S}_{n}} = \frac{\frac{1}{{a}_{{S}_{n}}}}{\frac{1}{{a}_{T}} + {\sum }_{n = 0}^{N - 1} \frac{1}{{a}_{{S}_{n}}}} & ( 14 )\end{matrix}$$

In consideration of a correct answer rate for supervised data of each of the divided discriminator networks, the image generation apparatus 100b configured as described above can extract a region for which the interpolator network is not comfortable or a region for which the discriminator network is comfortable. If weighting parameters during update in the interpolator network update process or the discriminator network update process are controlled by using this information, it is possible to intentionally and advantageously accelerate the training of the interpolator network or the discriminator network. As a result, it is possible to stabilize the training by a control method.

A modification common to each embodiment will be described below.

In each of the above-described embodiments, a missing image is described, in an example, for an image used for training, but the image used for training is not limited to a missing image. For example, an image used for training may be an up-converted image.

The embodiments of the present invention have been described above in detail with reference to the drawings. However, specific configurations are not limited to those embodiments, and include any design or the like within the scope not departing from the gist of the present invention.

### REFERENCE SIGNS LIST

11 . . . Missing region mask generating unit
12 . . . Missing image generation unit
13, 13a . . . Missing image interpolation unit
14, 14a, 14b . . . Interpolated image discrimination unit
15 . . . Update unit
16 . . . Image determination unit
17 . . . Weighting parameter decision unit
100, 100a, 100b . . . Image generation apparatus
141, 141a . . . Image dividing unit
142, 142a . . . Discrimination unit
143, 143b . . . Discrimination result integrating unit

1. A generation apparatus, comprising:
a processor; and
a storage medium having computer program instructions stored thereon, when executed by the processor, perform to:
generate, from a moving image including a plurality of frames, an interpolated frame in which a region in one or more frames of the plurality of frames included in the moving image is interpolated; and
discriminate whether a plurality of input frames are interpolated frames in which a region in the plurality of input frames is interpolated,
by discriminating time-wise the plurality of input frames to form a first discrimination result;
space-wise the plurality of input frames to form a second discrimination result; and integrating the first discrimination result with the second discrimination result.

2. The generation apparatus according to claim 1, wherein the computer program instructions uses time-series data of a frame in which an interpolated region in the plurality of input frames is extracted to output, as a discrimination result, a probability that the plurality of input frames are interpolated frames, and
uses a frame input at every input time to output, as a discrimination result, a probability that the plurality of input frames are interpolated frames.

3. The generation apparatus according to claim 1, wherein if a reference frame in which some or all regions in a frame are not interpolated is included in the plurality of input frames, and the computer program instructions
uses the reference frame and the interpolated frame to output, as a discrimination result, a probability that the plurality of input frames are interpolated frames, and
uses an interpolated frame from among the plurality of input frames at every input time to output, as a discrimination result, a probability that the plurality of input frames are interpolated frames.

4. The generation apparatus according to claim 3, wherein the reference frame includes two frames consisting of a first reference frame and a second reference frame, and the plurality of input frames includes at least the first reference frame, the interpolated frame, and the second reference frame in a chronological order.

5. The generation apparatus according to claim 1, wherein the computer program instructions updates, based on correct answer rates obtained as results of discriminations, parameters used for weighting.

6. A generation apparatus, comprising:
an interpolation unit trained by the generation apparatus according to claim 1,
wherein when a moving image is input, the interpolation unit generates an interpolated frame in which a region in one or more frames included in the moving image is interpolated.

7. A non-transitory computer-readable medium having computer-executable instructions that, upon execution of the instructions by a processor of a computer, cause the computer to:
an interpolation step of generating, from a moving image including a plurality of frames, an interpolated frame in which a region in one or more frames of the plurality of frames included in the moving image is interpolated; and
a discrimination step of discriminating whether a plurality of input frames is interpolated frames in which a region in the plurality of input frames is interpolated,
wherein in the discrimination step,
the plurality of input frames is discriminated time-wise,
the plurality of input frames is discriminated space-wise, and
discrimination results in the discrimination step are integrated.
